(19) United States
(12) Patent Application Publication
(10) Pub. No.: US 2023/0237037 A1
(43) Pub. Date: Jul. 27, 2023

(54) SYSTEM AND METHOD FOR CONCEPT CREATION

(71) Applicant: CONQ, Inc., Jacksonville, FL (US)

(72) Inventors: Mark S. O'Hare, Coto De Caza, CA (US); Richard L. Orsini, Flower Mound, TX (US)

(73) Assignee: CONQ, Inc., Jacksonville, FL (US)

(21) Appl. No.: 18/100,314

(22) Filed: Jan. 23, 2023

Related U.S. Application Data
(60) Provisional application No. 63/302,353, filed on Jan. 24, 2022.

(51) Int. Cl. G06F 16/22; G06F 16/21; G06F 16/28

(52) U.S. Cl. CPC G06F 16/2272; G06F 16/212; G06F 16/285

(57) ABSTRACT

Systems, methods, and non-transitory computer-readable storage media for concept creation, and more specifically to creating concepts in an automized process using data processing rules. A system can, upon receiving a request to generate a new concept data structure, receive data from a database and data sets. The system can then execute data processing rules on the data, resulting in processed data, and index and normalize that data. Using the index and the data processing rules, the system can organize the normalized data into a plurality of categories and create the new concept structure using the data processing rules, the index, and the categorized data.

### PRIORITY

This application claims priority to U.S. Provisional Pat. Application no. 63/302,353, filed Jan. 24, 2022, the contents of which are incorporated herein in their entirety.

### BACKGROUND

### 1. Technical Field

The present disclosure relates to concept creation, and more specifically to creating concepts in an automized process using data processing rules.

### 2. Introduction

Organizing data (structured and unstructured data) into concept groupings becomes increasingly complex as the amount of data increases. Likewise, the complexity can increase based on the different types of data being collected. For example, images, text, sounds, or other media all require different forms of analysis to normalize the data into a format where they can be compared. At that point, the analyst or system engineer determines if the identified information corresponds to the concept being defined and, if so, adds the data to the concept under construction. However, this manual process slows the concept formation process and can require duplication of data transmission and processing.

### SUMMARY

Additional features and advantages of the disclosure will be set forth in the description that follows, and in part will be understood from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media which provide a technical solution to the technical problem described. A method for performing the concepts disclosed herein can include: receiving, at a computer system, a request to generate a new concept data structure; receiving, at the computer system from at least one database in response to the request,data; executing, via a processor of the computer system, data processing rules on the data, resulting in processed data; indexing, via the processor using the data processing rules, the processed data, resulting in an index; normalizing, via the processor using the data processing rules, the processed data, resulting in normalized data; categorizing, via the processor using the index and the data processing rules, the normalized data into a plurality of categories, resulting in categorized data; and creating, via the processor using the data processing rules, the index, and the categorized data, the new concept data structure.

A system configured to perform the concepts disclosed herein can include: at least one processor; and a non-transitory computer-readable storage medium having instructions stored which, when executed by the at least one processor, cause the at least one processor to perform operations comprising: receiving a request to generate a new concept data structure; receiving, from at least one database in response to the request, data; executing data processing rules on the data, resulting in processed data; indexing, using the data processing rules, the processed data, resulting in an index; normalizing, using the data processing rules, the processed data, resulting in normalized data; categorizing, using the index and the data processing rules, the normalized data into a plurality of categories, resulting in categorized data; and creating, using the data processing rules, the index, and the categorized data, the new concept data structure.

A non-transitory computer-readable storage medium configured as disclosed herein can have instructions stored which, when executed by a computing device, cause the computing device to perform operations which include: receiving a request to generate a new concept data structure; receiving, from at least one database in response to the request, data; executing data processing rules on the data, resulting in processed data; indexing, using the data processing rules, the processed data, resulting in an index; normalizing, using the data processing rules, the processed data, resulting in normalized data; categorizing, using the index and the data processing rules, the normalized data into a plurality of categories, resulting in categorized data; and creating, using the data processing rules, the index, and the categorized data, the new concept data structure.

### BRIEF DESCRIPTION OF THE DRAWINGS

FIG. 1 illustrates a first example process flow;

FIG. 2 illustrates an example system embodiment;

FIG. 3 illustrates an example method embodiment; and

FIG. 4 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

A concept, as discussed herein, is a data structure containing information associated with a given topic, event, circumstance, etc., combination thereof. However, whereas a topic could be can be broadly defined by identifying a subject of a conversation or discussion, a concept data structure can include synonyms, directly related data, indirectly related data, timestamped information, names or other identifying information, and/or other information. Within the concept data structure the data can be linked using a system of weights. In some non-limiting example configurations, the concept data structure can be visually represented using a graph structure, where respective pieces of data stored within the graph structure are represented as nodes, and the links/edges connecting pieces of the data of the concept are weighted.

Unlike concept generation systems which rely on manual review of the data structure in order to compile or add to the concept data structure, systems configured as disclosed herein can automatically receive, process, and compile the information into a concept data structure. A user or engineer can then, if desired, review or validate the constructed concept, though this may not be necessary in all circumstances.

The system uses predefined data processing rules to extract data from documents. The data processing rules can define, for example how data is extracted from documents and input into modeling software. These rules can be programmed into the computer system, such that when a concept is being generated or augmented, documents can be reviewed and data extracted from the documents. Exemplary rules can be: 1) Any sentence containing the word “shall” becomes a requirement entry; 2) Any sentence containing the word “shall” and certain keywords becomes a constraint block entry; and 3) Any text inside rectangles in diagrams identified as “Block” will create a block entry.

Once the data processing rules are defined, those rules can be used to extract data to use in building or augmenting the concept. For example, with a new concept data structure being generated, the user can provide some initial information, then the system can retrieve data from one or more databases which may be related to the initial information. If, for example, the system were being used by law enforcement to look for a particular type of individual thought to be in a particular location on a given day, the user can input the individual’s appearance, probable location, and a time/date. The system can then use the data processing rules to request related data from various databases and filter out unrelated data.

Having obtained data related to the initial information, the system can then index and normalize the retrieved data. This indexing can, for example, be based on the type of data retrieved (e.g., video, text, audio, etc.), the time, the location, if obtained through second-hand resources, or other metadata aspects of the data. The data can also be indexed to include source (e.g., text, table, diagram) and/or the source type (e.g., the type of table, the type of diagram, etc.). The normalization can cause the data to be in a common data type (e.g., all video, all text, all audio, etc.), can modify the data in such a way to remove bias (e.g., removing or altering potentially prejudiced words or images), etc. The normalization can, for example, alter the data to correct spelling issues, eliminate duplication based on abbreviations and acronyms, or consolidate information based on concepts.

Once the data is normalized and indexed, the system can again use the data processing rules to categorize and format the indexed and normalized data, resulting in categorized data based on the rules. In some configurations, this process can result in the pieces of data being associated with various categories of information. Exemplary categories can include packages, requirements, actors, blocks, use-cases, control flow, etc. Likewise, this process can result in linked and/or weighted concept data structure formation. If, for example, the user is looking for a silver car sighted in a given location, the system may return data not only related to silver cars, but also grey cars. In the linked and/or weighted concept data structure, the silver cars may have a higher weight, indicating a higher likelihood of relatedness, than the grey cars-but both sets of data would be included in the resulting concept data structure.

The resulting categorized data can then be saved, extracted, shared, or otherwise used by users. In some configurations, the concept data structure can be imported into Model Based System Engineering (MBSE) or other modeling systems. MBSE software allows a systems engineer to fully document and visualize complex systems. One application of this technique would be to analyze legacy systems engineering specifications to automate the conversion of that data directly into the modeling software, replacing the costly and error prone method of manual conversion being done now. In this format, a user or systems engineer can view the concept data structure and validate the information contained therein.

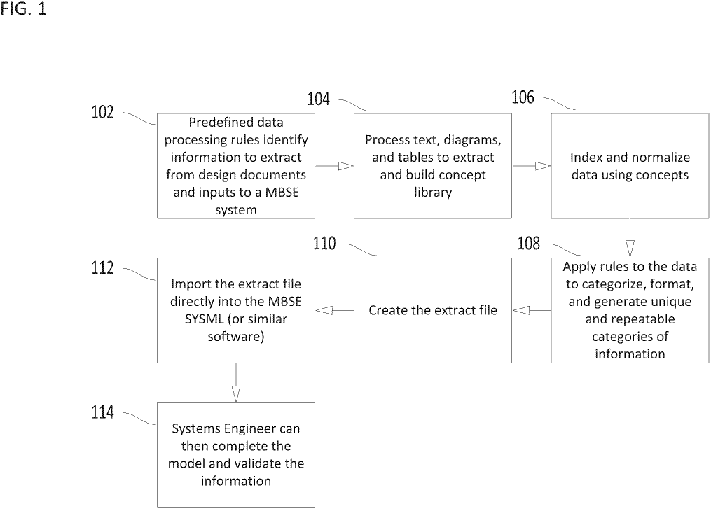

FIG. 1 illustrates a first example process flow. As illustrated, the model flow has the following steps:
1) Predefined data processing rules identify what information to extract from documents and input to MBSE system (102);
2) Process text, diagrams & tables to extract and build concept library (104);
3) Index and normalize data using concepts (106);
4) Apply rules to the data to categorize, format and generate unique and repeatable categories of information (108);
5) Create the extract file (a concept data structure) (110);
6) Import extract file directly into the MBSE software (112); and
7) Systems Engineer can then complete the model and validate the information (114).

In some configurations, various portions of these steps can be reordered, removed, or otherwise changed. For example, in some configurations the concept data structure file created may not be extracted, imported into MBSE software, and reviewed by a user or systems engineer. In other configurations, the concept data structure may already have been created, and the system is looking for additional data to augment to improve upon the data already gathered. In such cases, the system may be using the data processing rules to search for new or updated information from the documents, and be adding to the concept data structure rather than creating a new one.

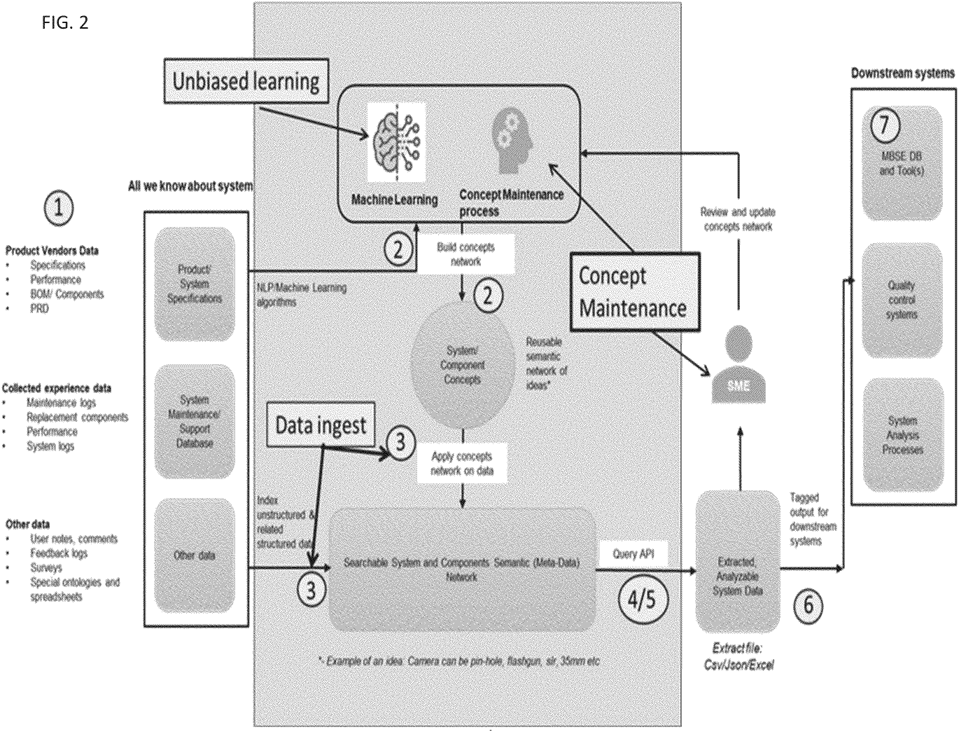

FIG. 2 illustrates an example system embodiment, with numbers within the illustration corresponding to the steps listed above. As illustrated, the documents can include product vendor’s data (such as specifications, performance, bill of materials (BOM), product review documents (PRD), collected experience data (such as maintenance logs, replacement components, performance, and system logs), and other data (such as user notes, comments, feedback logs, surveys, special ontologies, and spreadsheets). This information can be collected and compiled, then processed using Natural Language Processing (NLP) and/or machine learning algorithms applying the data processing rules discussed above. The machine learning can, for example, utilize a neural network, and in some configurations that neural network can be periodically updated based on newly received data. The resulting concepts network can link related concept data structures together, creating a reusable semantic network of ideas. As additional data is received/ingested into the system, the same data processing rules can be used to index and normalize data and structured data, then add related aspects to the concept data structure(s). The result is a searchable system and components semantic network, where the metadata associated with any given piece of data can be combined or linked to other pieces of data in a meaningful way.

Users of the system can extract the concept data structure, resulting in extracted, analyzable system data, which can be reviewed or updated by users. The extracted, analyzable system data can also be tagged for downstream systems, such as MBSE database tools, quality control systems, and/or system analysis processes.

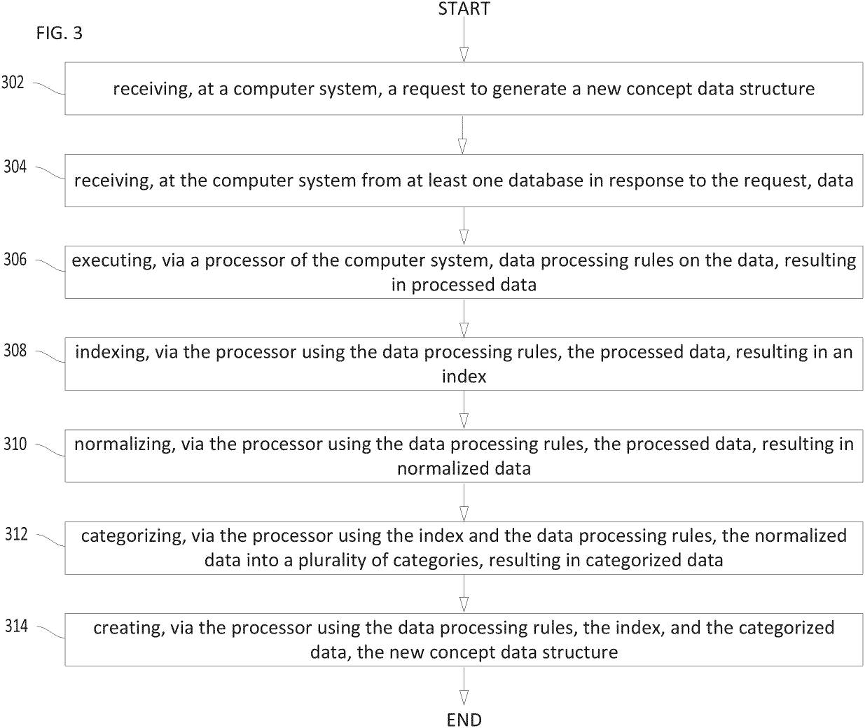

FIG. 3 illustrates an example method embodiment. As illustrated, the method can include receiving, at a computer system, a request to generate a new concept data structure (302), and receiving, at the computer system from at least one database in response to the request, data (304). The method continues by executing, via a processor of the computer system, data processing rules on the data, resulting in processed data (306); indexing, via the processor using the data processing rules, the processed data, resulting in an index (308); and normalizing, via the processor using the data processing rules, the processed data, resulting in normalized data (310). The method then categorizes, via the processor using the index and the data processing rules, the normalized data into a plurality of categories, resulting in categorized data (312); and creates, via the processor using the data processing rules, the index, and the categorized data, the new concept data structure (314).

In some configurations, the categorizing of the normalized data can further include: formatting the normalized data into predefined data formats.

In some configurations, the execution of the data processing rules on the data resulting in the processed data further relies on natural language processing of the data.

In some configurations, the illustrated method can further include: loading, via the computer system, the new concept data structure into a Model Based System Engineering (MBSE) computer program; and receiving feedback from a user regarding completeness of the new concept data structure via the MBSE computer program.

In some configurations, the new concept data structure can include a graph of nodes and edges, with nodes representing data and edges having weights indicating a level of relatedness between pieces of data.

In some configurations, the data processing rules utilize machine learning. In such configurations, the machine learning can be implemented using a periodically updated neural network.

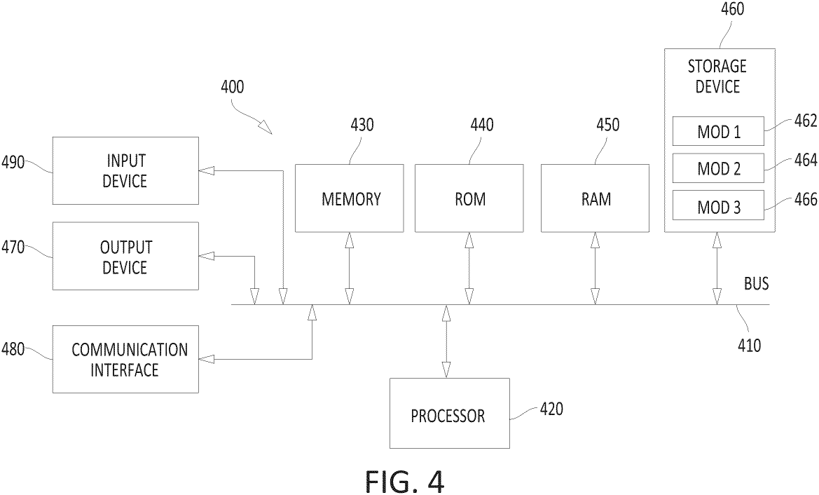

With reference to FIG. 4, an exemplary system includes a general-purpose computing device 400, including a processing unit (CPU or processor) 420 and a system bus 410 that couples various system components including the system memory 430 such as read-only memory (ROM) 440 and random access memory (RAM) 450 to the processor 420. The system 400 can include a cache of high-speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read-only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 470 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a computer system, a request to generate a new concept data structure;
receiving, at the computer system from at least one database in response to the request, data;
executing, via a processor of the computer system, data processing rules on the data, resulting in processed data;
indexing, via the processor using the data processing rules, the processed data, resulting in an index;
normalizing, via the processor using the data processing rules, the processed data, resulting in normalized data;
categorizing, via the processor using the index and the data processing rules, the normalized data into a plurality of categories, resulting in categorized data; and
creating, via the processor using the data processing rules, the index, and the categorized data, the new concept data structure.

2. The method of claim 1, wherein the categorizing of the normalized data further comprises:
formatting the normalized data into predefined data formats.

3. The method of claim 1, wherein the execution of the data processing rules on the data resulting in the processed data further relies on natural language processing of the data.

4. The method of claim 1, further comprising:
loading, via the computer system, the new concept data structure into a Model Based System Engineering (MBSE) computer program; and
receiving feedback from a user regarding completeness of the new concept data structure via the MBSE computer program.

5. The method of claim 1, wherein the new concept data structure comprises a graph of nodes and edges, with nodes representing data and edges having weights indicating a level of relatedness between pieces of data.

6. The method of claim 1, wherein the data processing rules utilize machine learning.

7. The method of claim 6, wherein the machine learning is implemented using a periodically updated neural network.

8. A system comprising:
at least one processor; and
a non-transitory computer-readable storage medium having instructions stored which, when executed by the at least one processor, cause the at least one processor to perform operations comprising:
receiving a request to generate a new concept data structure;
receiving, from at least one database in response to the request, data;
executing data processing rules on the data, resulting in processed data;
indexing, using the data processing rules, the processed data, resulting in an index;
normalizing the processed data using the data processing rules, resulting in normalized data;
categorizing the normalized data into a plurality of categories using the index and the data processing rules, resulting in categorized data; and
creating the new concept data structure using the data processing rules, the index, and the categorized data.

9. The system of claim 8, wherein the categorizing of the normalized data further comprises:
formatting the normalized data into predefined data formats.

10. The system of claim 8, wherein the execution of the data processing rules on the data resulting in the processed data further relies on natural language processing of the data.

11. The system of claim 8, the non-transitory computer-readable storage medium having additional instructions stored which, when executed by the at least one processor, cause the at least one processor to perform operations comprising:
loading the new concept data structure into a Model Based Systems Engineering (MBSE) computer program.

12. The system of claim 8, wherein the new concept data structure comprises a graph of nodes and edges, with nodes representing data and edges having weights indicating a level of relatedness between pieces of data.

13. The system of claim 8, wherein the data processing rules utilize machine learning.

14. The system of claim 13, wherein the machine learning is implemented using a periodically updated neural network.

15. A non-transitory computer-readable storage medium having instructions stored which, when executed by at least one processor, cause at least one processor to perform operations comprising:
receiving a request to generate a new concept data structure;
receiving, from at least one database in response to the request, data;
executing data processing rules on the data, resulting in processed data;
indexing, using the data processing rules, the processed data, resulting in an index;
normalizing the processed data using the data processing rules, resulting in normalized data;
categorizing the normalized data into a plurality of categories using the index and the data processing rules, resulting in categorized data; and
creating the new concept data structure using the data processing rules, the index, and the categorized data.

16. The non-transitory computer-readable storage medium of claim 15, wherein the categorizing of the normalized data further comprises:
formatting the normalized data into predefined data formats.

17. The non-transitory computer-readable storage medium of claim 15, wherein the execution of the data processing rules on the data resulting in the processed data further relies on natural language processing of the data.

18. The non-transitory computer-readable storage medium of claim 15, having additional instructions stored which, when executed by the at least one processor, cause the at least one processor to perform operations comprising:
loading the new concept data structure into a Model Based System Engineering (MBSE) computer program; and
receiving feedback from a user regarding completeness of the new concept data structure via the computer program.

19. The non-transitory computer-readable storage medium of claim 15, wherein the new concept data structure comprises a graph of nodes and edges, with nodes representing data and edges having weights indicating a level of relatedness between pieces of data.

20. The non-transitory computer-readable storage medium of claim 15, wherein the data processing rules utilize machine learning.
